(19) United States
(12) Patent Application Publication
(10) Pub. No.: US 2007/0271080 A1
(43) Pub. Date: Nov. 22, 2007

(54) Model generation method for software/hardware collaboration design

(75) Inventors: Masato Tatsuoka, Kawasaki (JP); Susumu Kashiwagi, Kawasaki (JP); Masahiko Toichi, Kawasaki (JP); Kazumasa Nakamura, Kawasaki (JP); Masayuki Tsuji, Kawasaki (JP); Takuya Hirata, Kawasaki (JP); Atsushi Ike, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/593,156

(22) Filed: Nov. 6, 2006

(30) Foreign Application Priority Data
May 16, 2006 (JP) 2006-136251

(51) Int. Cl. G06F 17/50

(52) U.S. Cl. 703/13

(57) ABSTRACT

A computer is made to execute the procedures of separating a hardware side from a software side within a reference source, and generating a merge model comprising a firmware interface for the software side to call the hardware side and comprising a hardware interface enabling an access to a mathematical function or a variable on the hardware side in response to a call from the firmware interface; and generating a system-on-chip (SoC) model comprising a CPU model for implementing a firmware interface with the software side, a hardware model for implementing the hardware side and a hardware interface connecting the CPU model to the hardware model.

### CROSS-REFERENCE TO RELATED APPLICATION

This application is based upon and claiming the benefit of priority from the prior Japanese Patent Application No. 2006-136251 filed in May 16, 2006, the entire contents of which are incorporated herein by reference.

### BACKGROUND OF THE INVENTION

1. Field of the Invention

The present invention relates to a method for designing a large scale integrated circuit for executing an application and specifically to a model generation method, for generating various models, which are used for a design, in phases in a manner to guarantee the same operation from a reference source of the application as software.

2. Description of the Related Art

Recently, widely used is a system-on-chip (SoC) equipping a central processing unit (CPU) and user hardware on a single chip as a large-scale integration (LSI) for implementing one application, e.g., an image processing of the H.264 system.

In the case of implementing such an image processing, an arithmetic operation volume becomes very large and therefore a more effective method for improving a process speed is to implement a large amount of data processing by hardware and make a CPU take part in control operations such as a time management. Accordingly used is a design procedure called a software/hardware collaboration design for appropriately determining a software/hardware division in order to determine as to which process the hardware is to take part in and to which process the software is to take part in.

FIG. 1 is a conventional example of a flow chart of an upstream design in a development of such a SoC. Referring to FIG. 1, a conventional design is such that a specification document corresponding to a concept model in response to a customer requirement, a specification document corresponding to a functional model and a specification document corresponding to a performance model are respectively written, followed by actually generating design models, i.e., a C/C++ model, a functional model and a performance model, based on the aforementioned respective specification documents, further followed by performing a design of a register transfer level (RTL). Note that it is of course possible to describe these specification documents by using a unified modeling language (UML) as a standard descriptive language for an object-oriented analysis design.

Conventionally, the above noted software/hardware division has been performed in a stage of a concept model responding to an application for instance, making it necessary to determine an interface between the divided software block and hardware block in that event. Then, a C/C++ model for example has been generated from the specification document corresponding to a concept model, and a C/C++ model or a SystemC model, as a functional model, has been generated from the specification document corresponding to a functional model. This functional model is an UnTimed functional model (UT) for which the highest level function is extracted without considering a time element. Then a SystemC model, as a performance model, has been generated from the specification corresponding to the performance model. This performance model is a Timed Functional model (TF) for which be extracted an operation sequence of individual functional blocks, a timing relationship, et cetera.

In such a conventional technique, there has been a problem of being unable to maintain interchangeability between models, resulting in a single operation not necessarily being guaranteed because concrete models which are utilized for the design are generated based on specification documents in the respective stages. For instance, there has been a problem of being unable to always guarantee a single operation for models due to a lack of connection between a C/C++ model, as UnTimed functional model, and a SystemC model, as Timed Functional model.

As a conventional technique relating to such a software/hardware collaboration design, a patent document 1 has disclosed a design method enabling an easy judgment for reducing a hardware volume effectively by changing a designation of a functional block appropriately among them or reducing a process time effectively thereby, in the case of being unable to satisfy a design limitation and changing a designation of an implementation by hardware.

Meanwhile, a patent document 2 has disclosed a performance evaluation method making it possible to calculate a bus traffic relating to a process rate of a bus connecting hardware and software, and perform a performance evaluation of the bus at a stage of an upstream design.

Even a use of the above noted conventional techniques has not been able to solve the problem of being unable to maintain an interchangeability of various models used for the upstream design and to guarantee a single operation.

[Patent document 1] Laid-Open Japanese Patent Application Publication No. 09-81604 “Software/hardware collaboration design system and its design method”

[Patent document 2] Laid-Open Japanese Patent Application Publication No. 2001-344287 “Performance evaluation method for a bus with an algorithm description”

### SUMMARY OF THE INVENTION

A purpose of the present invention is to generate, in phases, various models enabling the guarantee of the same operation while maintaining interchangeability among the models in the upstream designs of a system-on-chip specialized for a certain application for example and easing the design of the system-on-chip by tool using the models.

A method for generating a model according to the present invention is a method for performing a software/hardware collaboration design, wherein the method makes the computer execute the procedures of separating a hardware side from a software side within a reference source as application software and generating a merge model comprising a firmware interface for the software side to call the hardware side and comprising a hardware interface for enabling an access to a math function or a variable on the hardware side in response to a call from the firmware interface, and generating a system-on-chip model comprising a central processing apparatus model as a simulator capable of executing the software side and firmware interface within the merge model on an instruction level, a hardware model corresponding to the hardware side and the hardware interface for connecting the central processing apparatus model to the hardware model.

### BRIEF DESCRIPTION OF THE DRAWINGS

FIG. 1 is a flow chart of an upstream design according to a conventional technique;

FIG. 2A is a fundamental function block diagram of a model generation method for a software/hardware collaboration design according to the present invention;

FIG. 2B is a fundamental function block diagram of an another model generation method for a software/hardware collaboration design according to the present invention;

FIG. 3 is a basic process flow chart of a model generation method according to the present embodiment;

FIG. 4 is a diagram describing a relationship between a functional model generation flow and a performance model generation flow;

FIG. 5A is a diagram showing a configuration of a performance merge model;

FIG. 5B is a diagram showing a configuration of a performance merge model equipped with a bus;

FIG. 6 is a diagram showing a configuration of a performance model;

FIG. 7 is a diagram showing a configuration of a performance model equipped with a bus;

FIG. 8 is a basic process flow chart of a design method according to the present embodiment;

FIG. 9 is a process flow chart of generating a (b) Ref (hardware+software) model;

FIG. 10 is a description diagram of the (b) model generation example;

FIG. 11 is a description diagram of an operation concept for the (b) model;

FIG. 12 is a description diagram of an example making a firmware interface as a separate file;

FIG. 13 is a process flow chart for generating a (c) Ref-software+Ref-hardware model;

FIG. 14 is a description diagram of a generation example of the (c) model;

FIG. 15 is a description diagram of a register access method in the (c) model;

FIG. 16 is a description diagram of a memory access example (part 1) in the (c) model;

FIG. 17 is a description diagram of a memory access example (part 2) in the (c) model;

FIG. 18 is a description diagram of an Endian conversion in the (c) model;

FIG. 19 is a flow chart of a process for generating a (d) CPU model from the (b) model;

FIG. 20 is a flow chart of a process for generating the (d) CPU model from the (c) model;

FIG. 21 is a flow chart of a process for generating an (e) CPU+hardware model from the (c) model;

FIG. 22 is a description diagram of an operation between the CPU model and hardware model in the (e) model;

FIG. 23 is a description diagram of a startup example of a hardware block in the (e) model;

FIG. 24 is a description diagram of an example of a data write to a hardware register from a CPU core in the (e) model;

FIG. 25 is a description diagram of an example of a memory access from a hardware block in the (e) model;

FIG. 26 is a flow chart of a process for generating an (f1) performance merge model and an (f2) merge model equipped with a bus from the (c) model;

FIG. 27 is a description diagram of a generation example of the (f1) performance merge model;

FIG. 28 is a flow chart of a process for generating a (g1) performance model and a (g2) performance merge model equipped with a bus from the (e) model;

FIG. 29 is a description diagram of a verification method for the (c) Ref-software+Ref-hardware model;

FIG. 30 is a description diagram of a verification method for user hardware by utilizing the (c) Ref-software+Ref-hardware model;

FIG. 31 is a flow chart of a verification process for FIG. 30;

FIG. 32 is a description diagram of a process by using a design tool equipped with a graphical user interface (GUI); and

FIG. 33 is a diagram describing a loading of a program about a method for generating a model onto a computer according to the present invention.

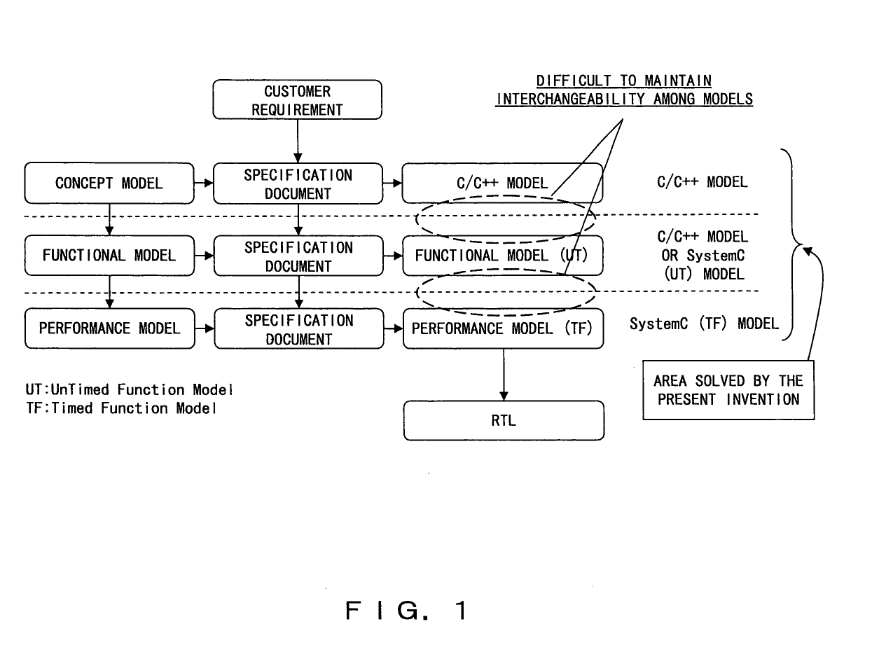

### DESCRIPTION OF THE PREFERRED EMBODIMENTS

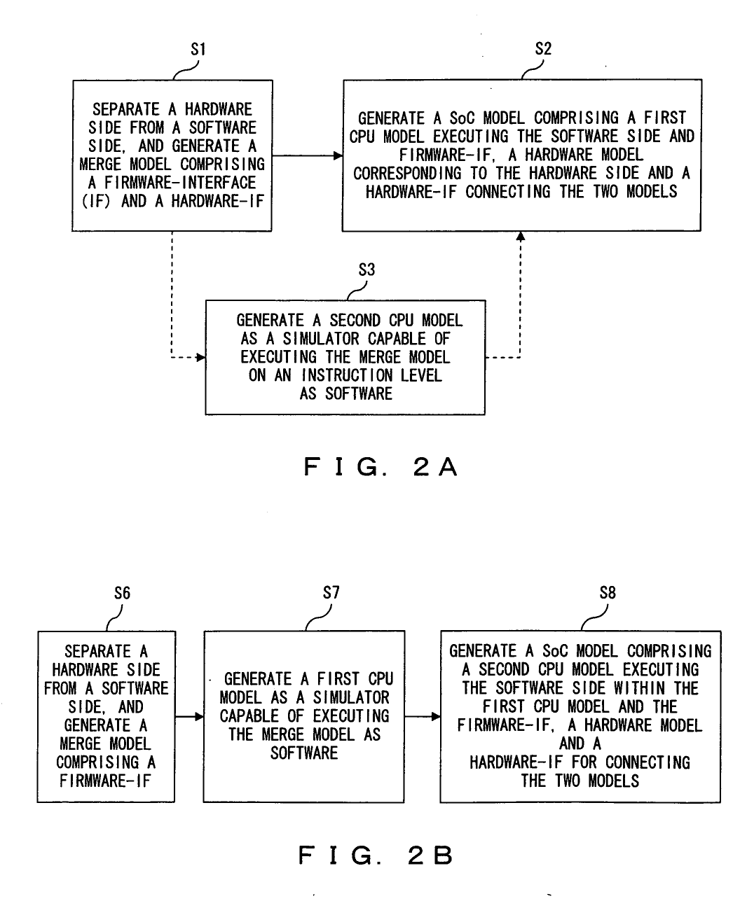

FIGS. 2A and 2B are fundamental function block diagrams of two model generation methods for a software/hardware collaboration design according to the present invention. According to an embodiment of the present invention, many kinds of models generated as functional models and performance models, all of those models, however, may not be necessary generated in phases. The description here is of means for solving a problem by defining a generation sequence of the most fundamental models as two, i.e., FIG. 2A and FIG. 2B.

In a configuration shown by FIG. 2A, first, a computer executes the procedure of separating a hardware side from a software side within a reference source as application software, and generating a merge model comprising a firmware interface for the software side to call the hardware side and comprising a hardware interface for enabling an access to a mathematical function (which is noted as “math function” hereinafter for defining separately from a function such as of a mechanism) or a variable on the hardware side in response to a call from the firmware interface in the step S1, and the procedure of generating a system-on-chip model comprising a first central processing apparatus model as a simulator capable of executing the software side and firmware interface within the merge model on an instruction level, a hardware model corresponding to the hardware side and the hardware interface for connecting the first central processing apparatus model to the hardware model in the step S2.

An embodiment of the present invention is configured to further execute the procedure of generating a second central processing apparatus model as a simulator capable of executing the above noted merge model on an instruction level as software between the steps S1 and S2.

In a configuration shown by FIG. 2B, executed is the procedure of separating a hardware side from a software side within a reference source as application software, and generating a merge model comprising a firmware interface for the software side to call the hardware side in the step S6, and the procedure of generating a central processing apparatus model as a simulator capable of executing the merge model and a hardware interface enabling an access to a math function or a variable on the hardware side in response to a call from the firmware interface on an instruction level as software in the step S7.

An embodiment of the present invention is configured to further execute the procedure of generating a system-on-chip model comprising a second central processing apparatus model as a simulator capable of executing the software side within the first central processing apparatus model and the firmware interface on an instruction level where the central processing apparatus model is defined as a first central processing apparatus model, a hardware model corresponding to said hardware side, and the hardware interface for connecting the second central processing apparatus model to the hardware model in the step S8.

As described above, the present invention is contrived to generate various models in phases in the form of maintaining interchangeability among them and guaranteeing the same operation in an upstream design stage of a system-on-chip for example, and perform the design by using those models.

Therefore, it is possible to generate a series of models, such as a merge model, a central processing apparatus model, and a system-on-chip model, in phases depending on necessity and in the form of maintaining interchangeability among them in the upstream design stage of a system-on-chip for example, and perform the design by using those models according to the present invention.

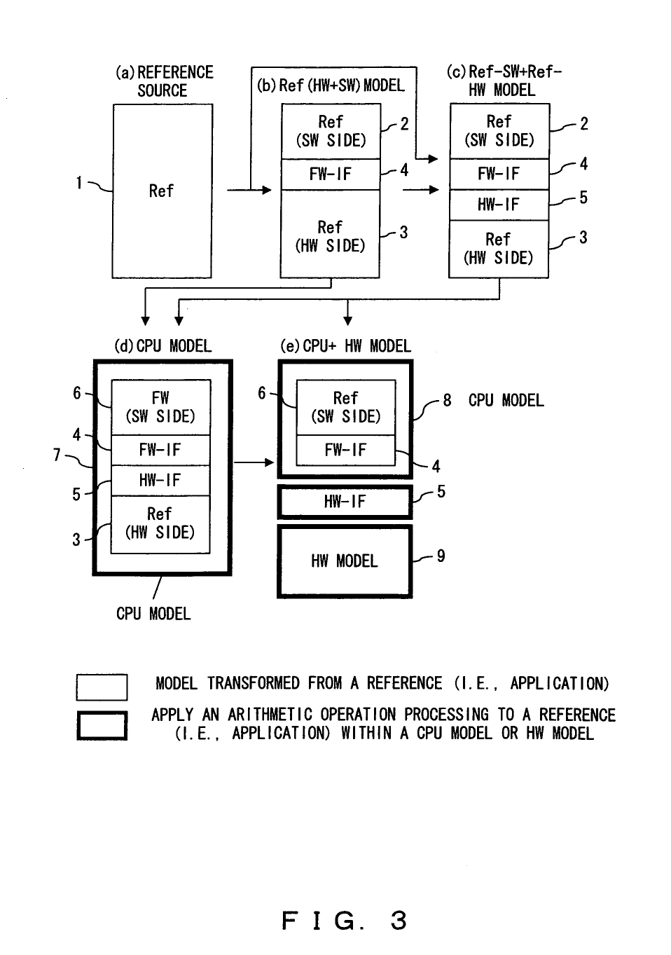

FIG. 3 is a diagram describing a generation method of a functional model in phases according to the present invention. Referring to FIG. 3, functional models are generated in phases from a reference source as an (a) model. Here, the reference source is a source of a reference (Ref) and its code is called a reference code. In order to describe an embodiment of the present invention by taking, as a subject, the case of developing MPEG CODEC as an application satisfying a MPEG 4 standard for example, the present embodiment names such an application as reference.

For FIG. 3, the description is of the course, as modeling, until eventually generating an (e) model, that is, a system-on-chip (SoC) model from a reference source as the (a) model. The eventual (e) model is also called a CPU+hardware (“HW” hereinafter) model which can be built in as a simulator for a software development tool.

Referring to FIG. 3, a (b) model or (c) model is generated first from the (a) model. The (b) model is also called a Ref (HW and software (“SW” hereinafter) model and is a model dividing a reference, that is, Ref1 into a software (SW) side and a hardware (HW) side by a firmware interface (FW-IF). Generally in a design of a system-on-chip (SoC), how a necessary process for executing an application shall be divided into a hardware side and a software side is a very important problem in order to improve process efficiency. In an image processing, et cetera, for example, a process such as an arithmetic operation of a large volume of image data yields a higher speed by hardware as compared to software, while the software side yields higher efficiency in executing a control operation, such as a time management, for example. In any event, how to divide the entire process into a software side and a hardware side is a very difficult problem, whereas the description of embodiments of the present invention assumes that such a division is already determined.

In the (b) model, that is, the Ref (HW+SW) model, a variable and a math function which belong to the hardware side, as Ref (HW side) 3, are separated from a Ref (SW side) 2 by a firmware interface (FW-IF) 4. The Ref (SW side) 2 calls an interface function of the FW-IF 4, thereby a math function or variable on the hardware side being processed.

Note that the present embodiment calls, as merge model, a model dividing an application into a software side and a hardware side and connecting them together by an interface as described above. The next (c) model is also a merge model, and therefore the (b) model is called a first merge model.

The (c) model is also called a Ref-SW+Ref-HW model, which is the (b) model further added by a hardware interface (HW-IF) 5. Here, the HW-IF 5 is an interface for accessing to memory and a register from the hardware side, and the above noted FW-IF 4 is an interface for accessing to memory and a register from software such as a program.

That is, in the (c) model (i.e., a second merge model), a HW-IF 5 for accessing a math function or a variable on the hardware side in the (b) model is defined, and the FW-IF 4 calls an application program interface (API) math function of the HW-IF 5, thereby an access to the hardware being judged and the API math function enabling a call to a math function of the Ref (HW side) 3 or an access to a variable. This results in the Ref (SW side) 2 calling the hardware side by using an interface named the HW-IF 4, which is an original type of a driver.

A use of the (c) model makes it possible to separate the software side from the hardware side completely, and further carry out a tuning of the software such as a change of algorithm by loading the software side onto a CPU. The present embodiment calls the software, as firmware (FW), which is changed from a reference source by such a tuning. If there is no change, it may also be called a Ref (SW side) as described above.

Note here that the description has referred to the (c) model as a (b) model added by a hardware interface (HW-IF) 5, it is, however, possible to generate the (c) model directly from the reference source, i.e., the (a) model, in lieu of generating the (c) model from the (b) model. That is, it is possible to generate a second merge model as (c) model directly from the reference source, i.e., the (a) model, in lieu of generating the second merge mode from a first merge model, i.e., the (b) model.

A (d) model is also called a CPU model and is a model for validating an operation by loading, as software, the (b) model, i.e., the Ref (HW+SW) model, or the (c) model, i.e., the Ref-SW+Ref-HW model. The CPU model can use a unique assembler as a Ref (SW side) 2 of the (b) and (c) models, and because of it, the software is also interpreted as a firmware FW (SW side) 6. Note that the CPU model can also be considered as a simulator being capable of executing a program on an instruction level, e.g., an instruction set simulator (ISS).

The (e) model is also called a CPU+HW model or system-on-chip (SoC) model. This model can be directly generated from the (d) model, i.e., the CPU model, or from the (c) model, i.e., the Ref-SW+Ref-HW model. In this model, a CPU model 8 constituted by software or the FW (SW side) 6 and FW-IF 4 as firmware is connected to a HW model 9 by way of the HW-IF 5. As described later, the HW-IF 5 is disposed for performing an Endian conversion at the time of a read/write access to the memory of the entirety of the SoC or the HW register, and an information collection on an access frequency to memory, et cetera. And the HW model 9 may be one appropriating the Ref (HW side) 3, or one implementing an algorithm of the hardware to be designed. This model can be built in as a simulator for a software development tool as described above.

As such, the present invention is configured to use a modeling method in the form of the (b) and (c) merge models being transformable to a program for a CPU model on the models (d) and (e), thereby guaranteeing the same operation for the respective models.

The (b) through (e) models generated from the reference source of the (a) model shown in FIG. 3 are equivalent to functional models. Each of the models is designed in a manner that an output value relative to an input to each model indicates the same arithmetic operation result. This configuration enables a verification of a software development such as an algorithm or code change of software and that for an algorithm or architecture change of hardware.

Particularly in three models, i.e., the (c), (d) and (e) models, a changeover of the firmware interface (FW-IF) 4 side calling a hardware function or a reference source enables a SW/HW collaboration verification as described later.

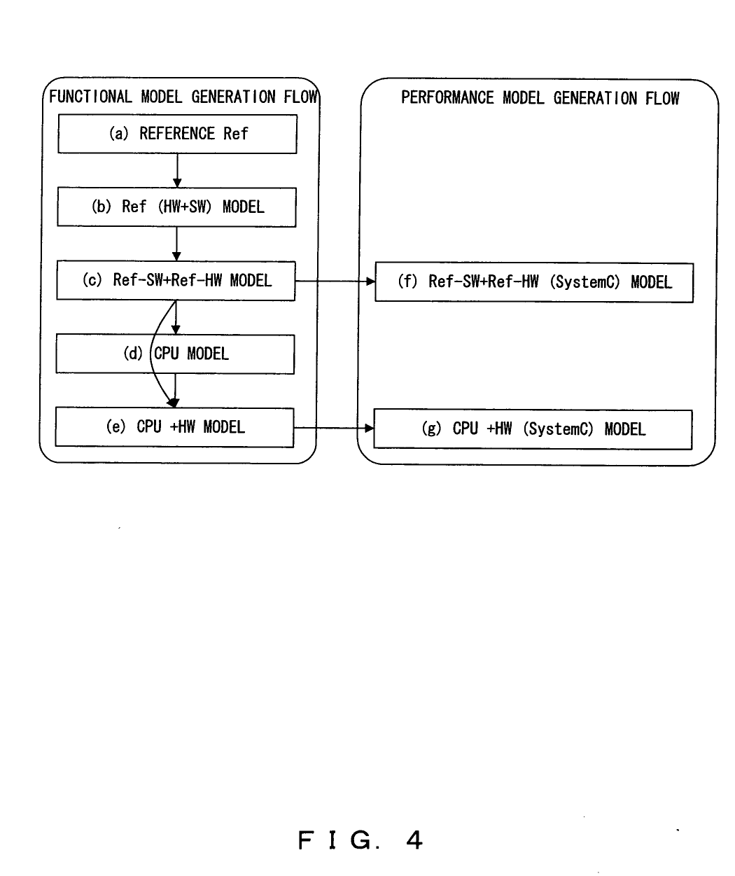

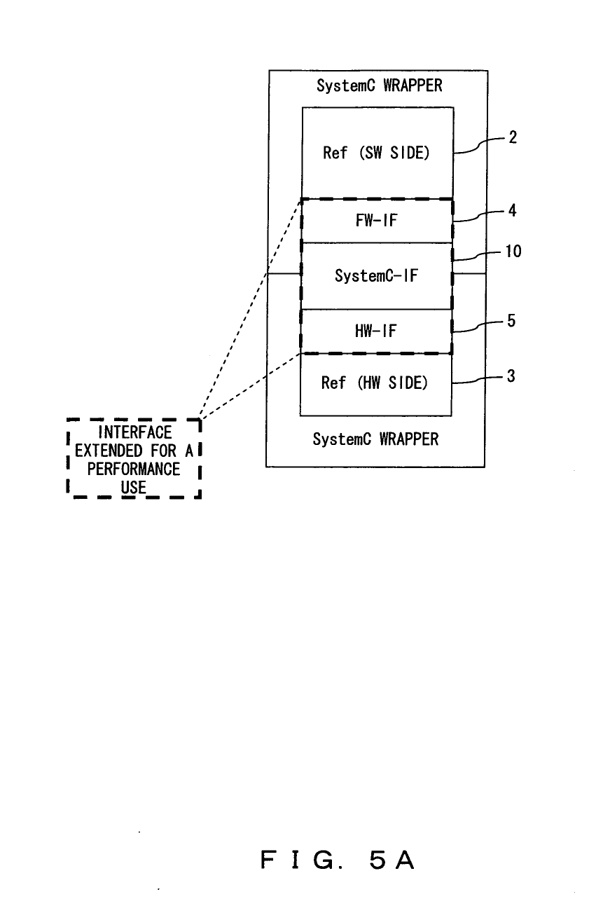

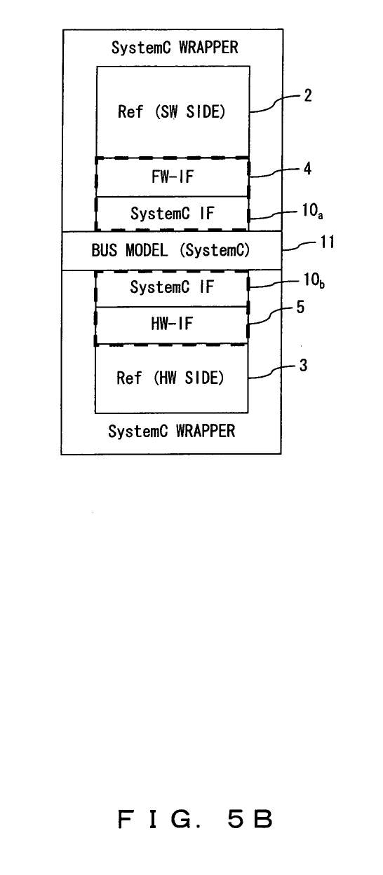

The next description is of the generation of performance models by using FIGS. 4 through 5B. FIG. 4 is a diagram showing a relationship between a functional model generation flow and a performance model generation flow. There are two performance models, i.e., an (f) model, that is, a Ref-SW+Ref-HW (SystemC) model, and a (g) model, that is, a CPU+HW (SystemC) model, where the (f) model is generated from the (c), that is, the Ref-SW+Ref-HW model and is called a performance merge model since it is generated from the second merge model. Meanwhile, the (g) model is generated from the (e) model, that is, the CPU+HW model, and is a performance model equivalent to a simulator since it is generated from the (e) model which can be built in as a simulator.

FIGS. 5A and 5B are conceptual diagrams of an (f) model, that is, a performance merge model. This model is generated from the (c) model, that is, the Ref-SW+Ref-HW model; specifically, applying a SystemC code to the Ref (SW side) 2 and Ref (HW side) 3 of the (c) model, that is, using a SystemC wrapper, thereby converting a C/C++ model into a SystemC model, connecting the FW-IF 4 and HW-IF 5 by way of a SystemC interface 10 and generating the (f) model with the aforementioned interfaces being extended for using for a performance model. This is an (f1) model shown in FIG. 5A.

FIG. 5B is an (f2) model capable of executing a parallel operation including a bus by using a bus model 11 describing the bus connecting the SW side to HW side by a C/C++ and SystemC, in which the SystemC interface 10 is divided into 10a on the software side and 10b on the hardware side and the software side is connected to the hardware side by a SystemC bus model 11.

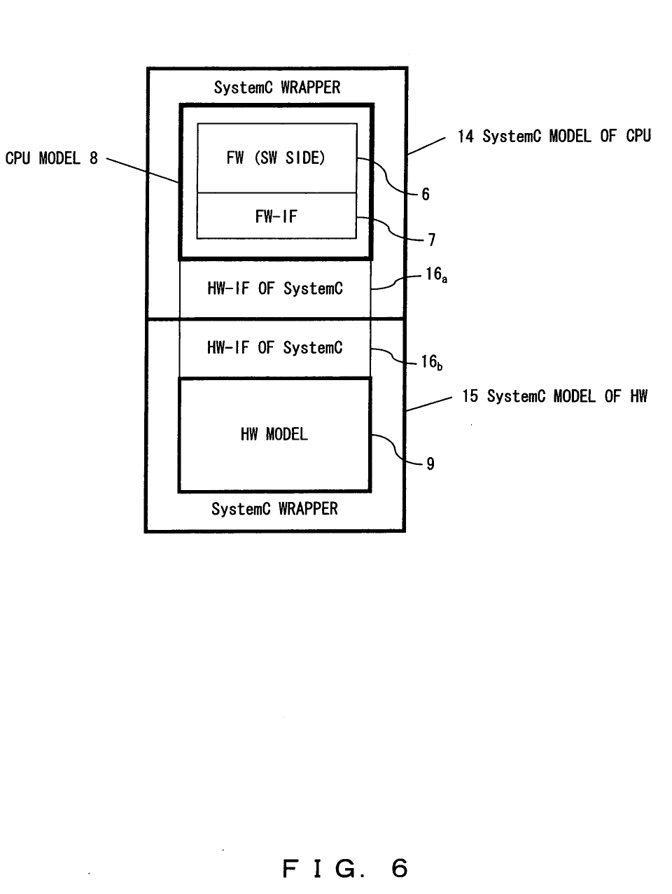

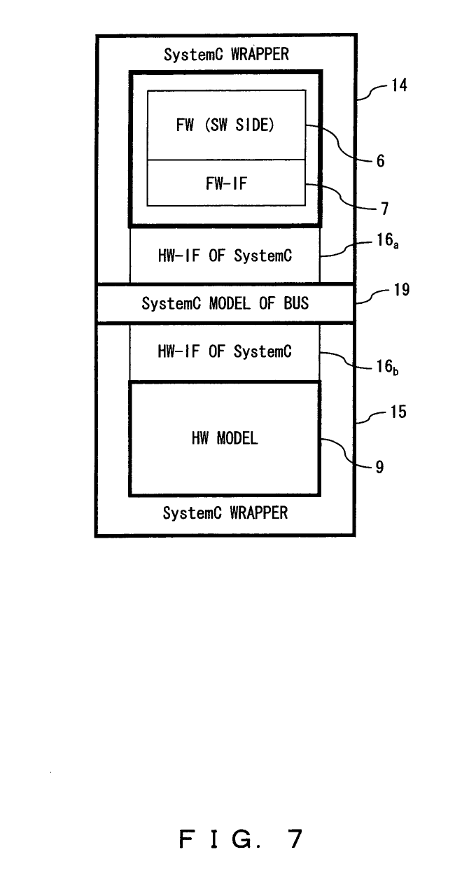

FIGS. 6 and 7 are conceptual diagrams of the (g) model. The (g) model, that is, the CPU+HW (SystemC) model as a performance model equivalent to a simulator, is generated from a system-on-chip model, that is, an (e) CPU+HW model, of which two kinds, i.e., one with a bus model and another without, can be generated as in the case of the performance model shown in FIGS. 5A and 5B.

FIG. 6 is a (g1) model without a bus model which is constituted by a SystemC model of CPU 14 and a SystemC model of HW 15 (N.B.: these “of” followed by component numbers herein, but not limited thereto, mean grammatically “apposition” instead of possession). The SystemC model of CPU 14 is in the form of the CPU model 8, which is constituted by the FW (SW side) 6 and FW-IF 7, and a HW-IF of SystemC 16a being applied by a SystemC code by a SystemC wrapper, while a SystemC model of HW 15 is in the form of the HW model 9 and HW-IF of SystemC 16b being applied by the SystemC code.

FIG. 7 is a diagram showing a configuration of a (g2) model as another performance model equivalent to a simulator. FIG. 7 shows the form of the SystemC model of CPU 14 and SystemC model of HW 15, which is described for the (g1) model shown in FIG. 6, being connected together by a SystemC model of bus 19 in the same manner as FIG. 5B.

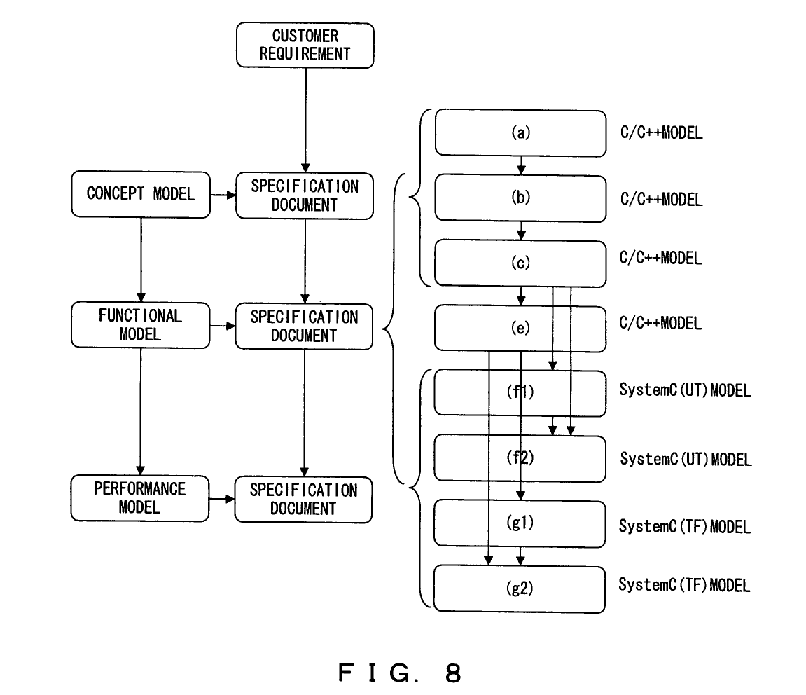

FIG. 8 is an overall process flow chart of a modeling flow for generating each functional model and performance model from a reference source as an application, that is, a design flow of a system-on-chip, according to the present embodiment. The three specification documents, i.e., the specification document corresponding to a concept model, one corresponding to a functional model and one corresponding to a performance model, which are made in response to a customer requirement, are considered as the integrated specification document, and each functional model and performance model are generated from the (a) reference source in the form of having interrelations in phases, thereby making it possible to correlate between the models and provide the environment for a smooth design and verification of the system-on-chip.

Referring to FIG. 8, the (a) through (e) models are C/C++ models for example, the performance models (f1) and (f2) are UnTimed functional (UT) models of SystemC, and the performance models (g1) and (g2) are Timed Functional (TF) models of SystemC. Meanwhile, a (d) model is omitted here, while it is of course possible to generate the (d) model from (c) model, and the (e) model from (d) model as described in association with FIG. 3.

With this, the description of a basic generation method of the functional models and performance models according to the present embodiment is finished, followed by a detailed description of a generation of each model and its operation.

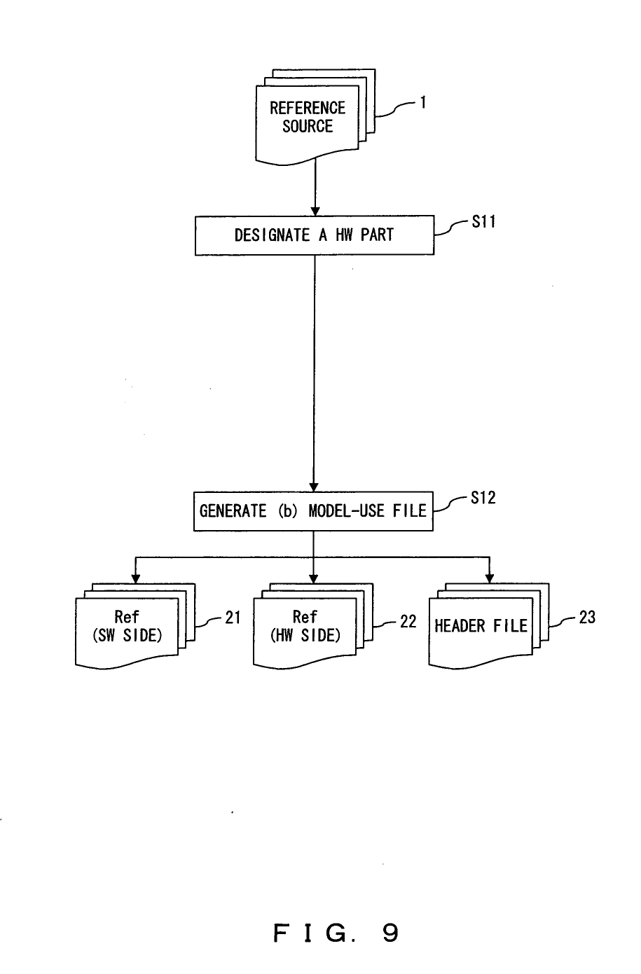

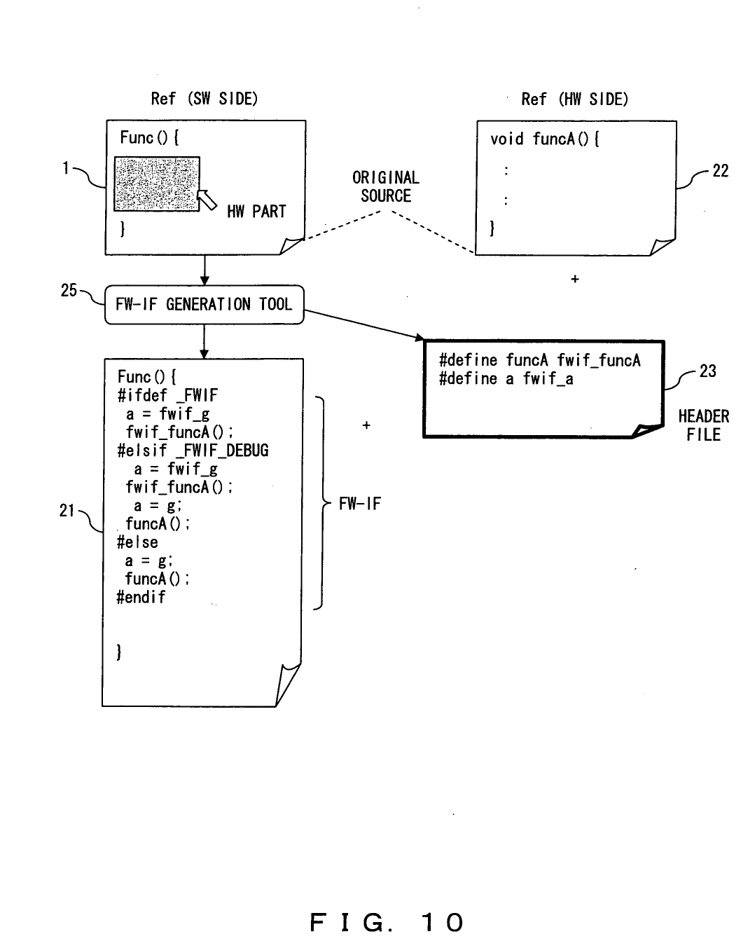

FIG. 9 is a process flow chart of the generation of the (b) model, that is, the Ref (HW+SW) model. Referring to FIG. 9, the step S11 designates a hardware part to be divided from a software part relating to software such as an application, that is, to an (a) reference source 1. That is, the division of SW and HW is performed on the application. The division of the SW and HW is specifically performed by designating a hardware part within software because the reference source is basically software. The designation method includes one for manually rewriting a reference source and one for automatically performing by designating, by a tool, a math function to be handled as a hardware part. Herein, the designation is automatically performed by designating on the tool, for example.

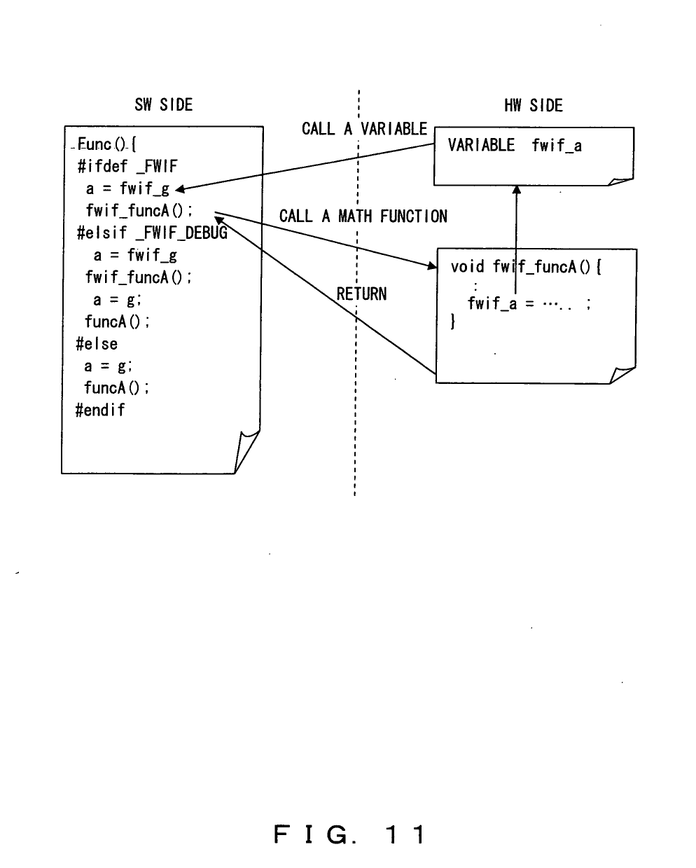

The subsequent step S12 generates a (b) model-use file. While the generation is further described in association with FIG. 10 in the following, the resultantly generated files are three, i.e., a source code 21 embedding the FW-IF 4 which is equivalent to the Ref (SW side) 2 shown in FIG. 3, a header file 23 for defining a hardware part for dividing into SW and HW parts and a file 22 equivalent to the Ref (HW side) 3.

FIG. 10 is a description diagram of a generation example of the (b) model, that is, the Ref (HW+SW) model. As described for FIG. 9, designated is a code position of a math function or a variable to be handled as a hardware part (HW) within a reference source, and generated are a Ref (SW side) 21 embedding a firmware interface by a FW-IF generation tool 25, a header file 23 being generated for a SW and HW division and a Ref (HW side) 22.

As such, the Ref (HW+SW) model of (b) becomes the form of a math function or variable as a hardware part being designated by an interface math function and called. In FIG. 10, a math function func A ( ) and a variable g within a reference source are defined as a hardware part. A variable to be on the hardware side has a directional property when viewed from the software side, and variables are categorized into a readout, that is, a read variable, and a write, that is, a write variable.

In FIG. 10, the fwif_g is a read variable from the HW side for the SW side. Letting an “a” be a variable for the SW side to write data to the HW side, then:

fwif_a=g

As for a math function for the HW side, a single math function per se is handled as a HW block.

As for the name of a variable or math function, a process such as renaming is not required for one used only in the SW side or HW side, whereas a renaming, as different names for use in the SW and HW sides, is required for a variable and a math function used commonly in the SW and HW sides.

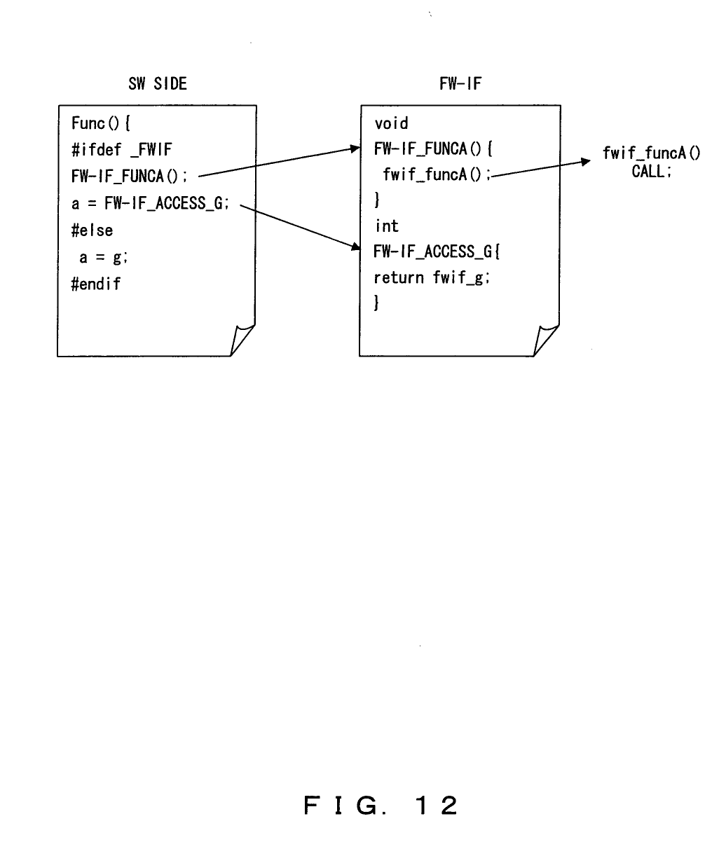

FIG. 11 is a description diagram of an operation concept for the Ref (SW+HW) model, in which a variable of the HW side is called at a discretionary position of the SW side and a math function is called, followed by returning to the SW side upon completion of a process on the HW side.

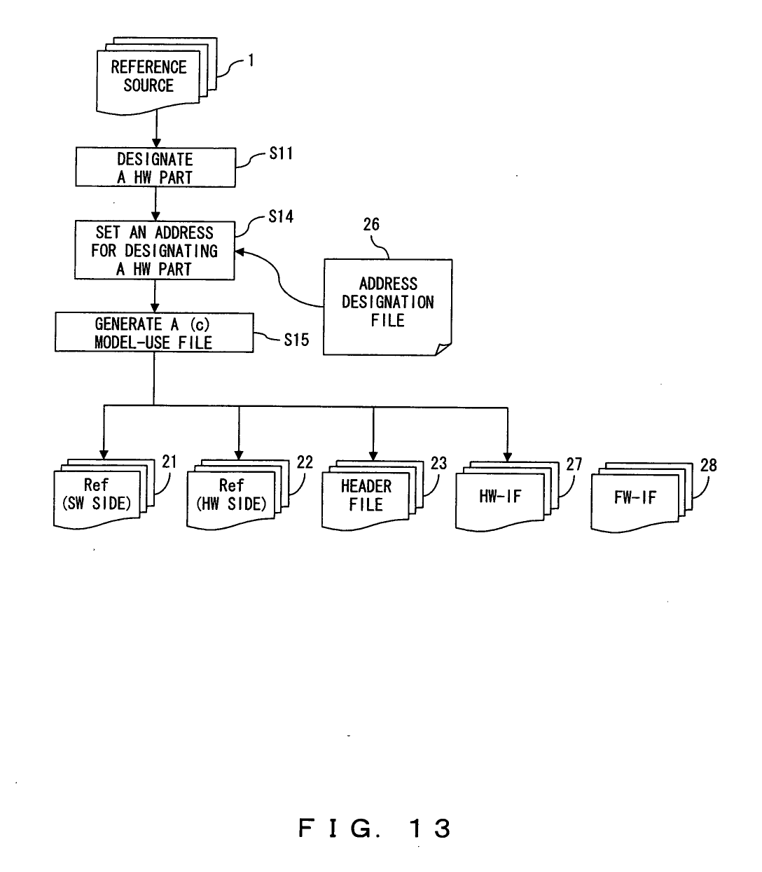

FIG. 12 is an example of defining a firmware interface as a separate file in lieu of embedding it in the original source, which is different from the configuration shown in FIG. 10. In FIG. 12, the FW-IF is written to a separate file from the SW part, and a math function is called by the FW-IF.

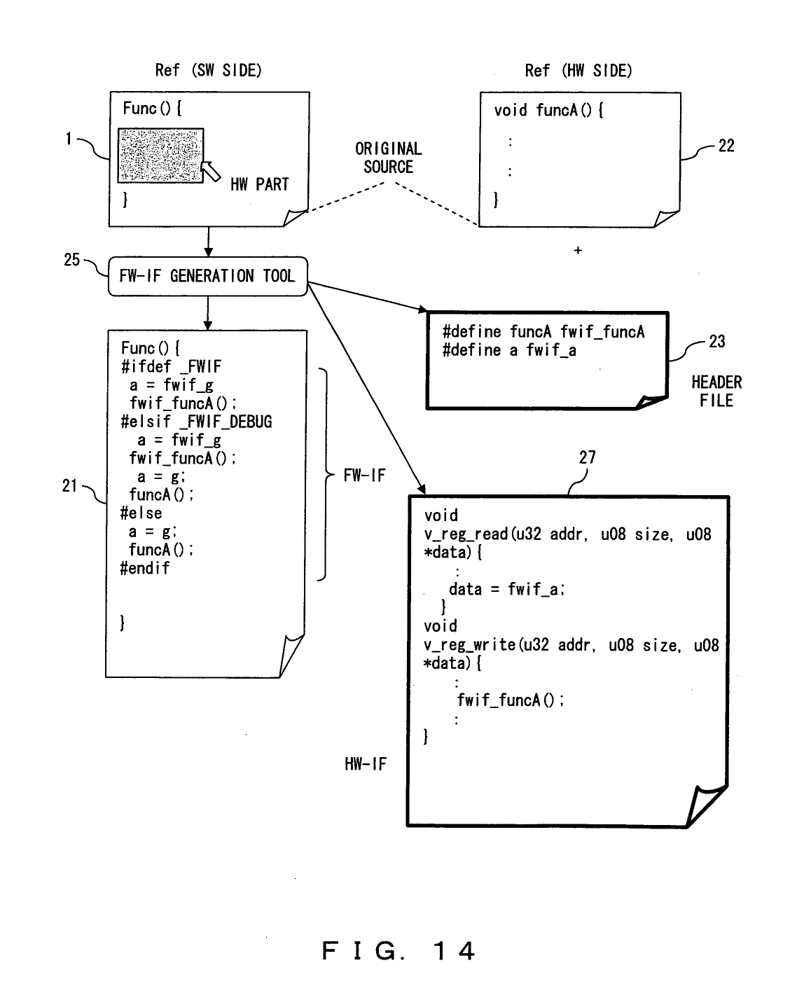

FIG. 13 is a process flow chart for generating the second merge model, that is, the (c) Ref-SW+Ref-HW model. In FIG. 13, the step S11 designates a HW part by a mark, and the step S14 sets an address for designating the HW part by using a content of an address designation file 26, for example, for the reference source 1 such as an application, as in the case of FIG. 9. Here, the address is one to be designated for calling a HW block as a math function within a HW part, and the address is set automatically by reading a content of the address designation file 26, or by specified by a user by way of a GUI.

The subsequent step S15 performs a (c) model-use file generation process, generating files, i.e., the Ref (SW side) 21 as a source code embedding the FW-IF as in the case of FIG. 9, Ref (HW side) 22 and header file 23, and, additionally, a hardware interface (HW-IF) 27. Note that a FW-IF 28 can also be defined as a separate file as described in association with FIG. 12.

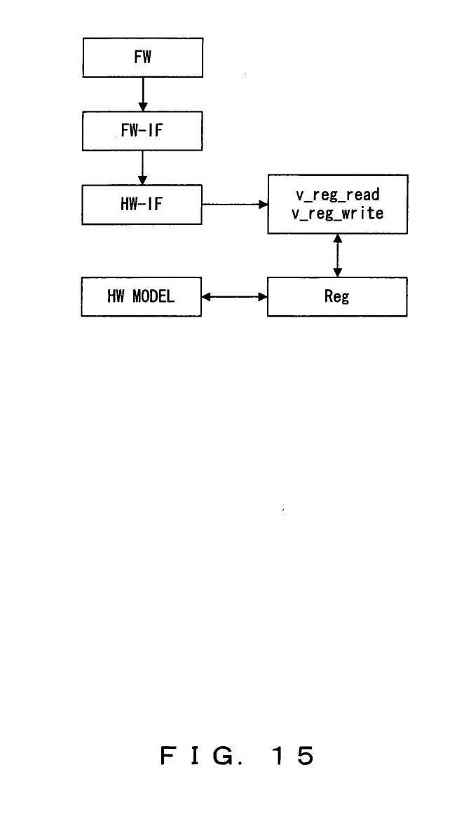

FIG. 14 exemplifies a generation of (c) Ref-SW+Ref-HW model as the second merge model, generating a reference source 21 being embedded a FW-IF by a FW-IF generation tool 25, a Ref (HW side) 22 and a header file 23 from the reference source 1, and further a HW-IF 27 as in the case of FIG. 10. Here, the HW-IF 27 performs a read/write access to a register or memory by using a math function called “v_reg_read/write”, and by using an address, a size and a data type for example.

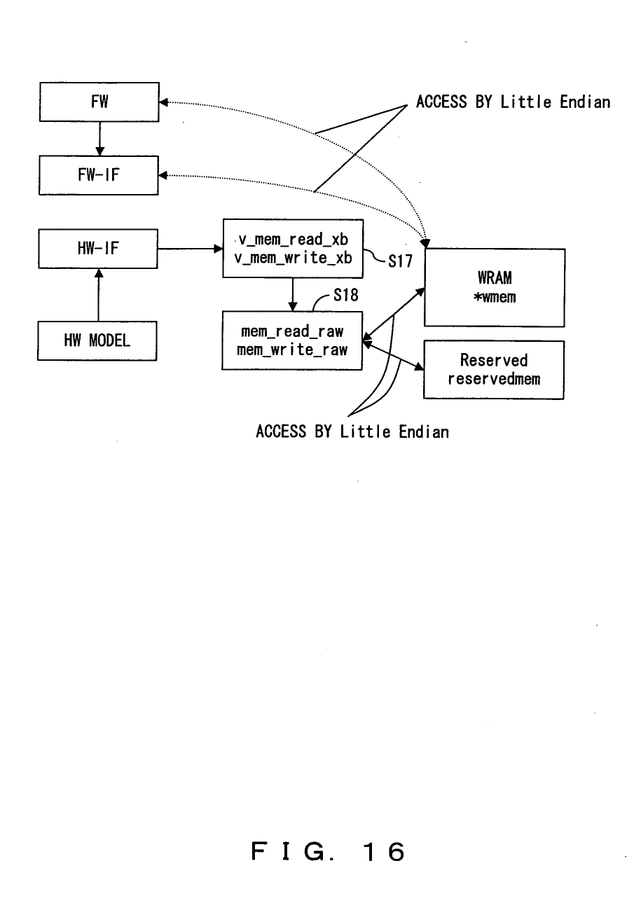

FIGS. 15 through 18 are diagrams each describing an access to a register or memory. FIG. 15 is a description diagram of a register access which is performed, by way of the FW-IF and HW-IF, by using the above described math function from the Ref (SW side) or the firmware (FW) side for which a reference source has been changed. A direct access is performed to a register for the Ref (HW side), e.g., the HW model of C model.

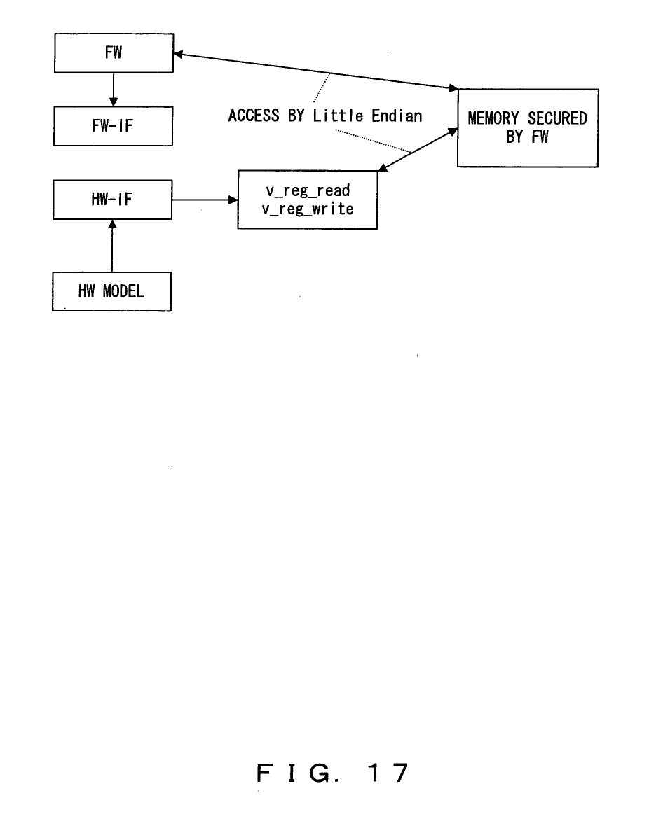

FIG. 16 is a description diagram of an access to an internal memory of a SoC other than an external memory, e.g., an access to a work RAM (WRAM) or a reserve zone of an internal memory. An access is performed by a little Endian, as described later, to WRAM or a reserve zone from a FW side by way of a FW-IF. From a HW model, a read/write access by every 1, 2 or 4 bytes is performed by way of a HW-IF in the step S17, while a process equivalent to an Endian conversion is performed in the step S18 in order to access to the WRAM or the reserve zone by the little Endian, thereby performing an access to the WRAM or the reserve zone. A further description of the Endian conversion is provided later.

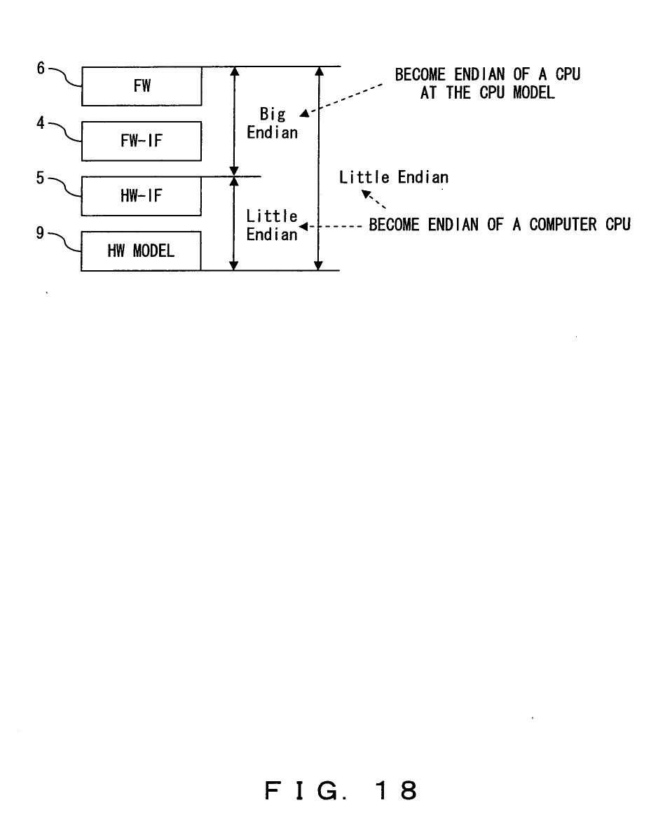

FIG. 17 is a description diagram of an access operation to memory of a SoC model other than the WRAM or reserve zone which has been described for FIG. 16. For example, a FW accesses directly by the little Endian to memory secured by itself, while a HW model accesses to memory secured by the FW by the little Endian by using a HW-IF.

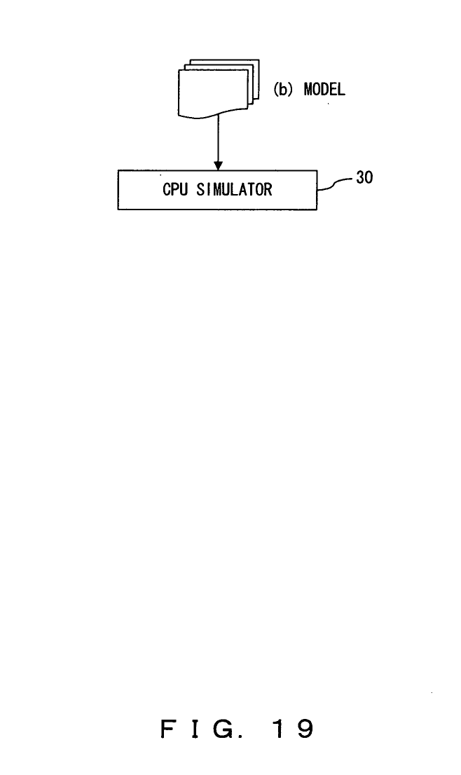

FIG. 18 is a description diagram of an Endian conversion in the second merge model. An access by a big Endian for example is required at a later described CPU core model as an Endian of the CPU, while all are unified to the little Endian in Microsoft Visual C++ (VC++), for a second merge model. Therefore, in the case of accessing to the WRAM or reserve zone for example as described for FIG. 16, an access is performed by the little Endian both from the FW side and the HW side. Because of this, the function of the Endian conversion is required for the HW side for example on an as required basis.

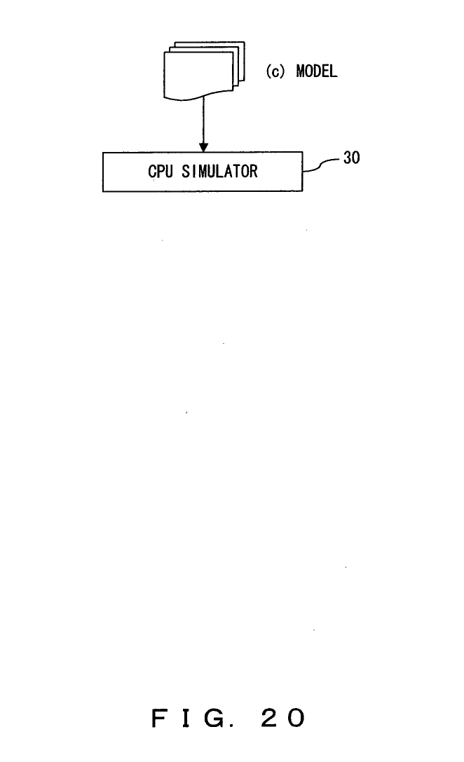

FIGS. 19 and 20 each is a flow chart of generating a (d) model, that is, a CPU model. A (b) Ref (HW+SW) model is provided to a CPU simulator 30 in FIG. 19, while a (c) Ref-SW+Ref-HW model is provided thereto in FIG. 20, and these models are enabled to execute at a CPU model immediately because they are programs.

Since the HW side is separated from the SW side including the FW-IF 4 of the (b) and (c) models at the CPU model, it is possible to carry out a further optimization by a change in algorithm, et cetera. And, the HW side is also software and therefore the verification is enabled within the CPU model. Note that the CPU model can utilize the above noted ISS for example.

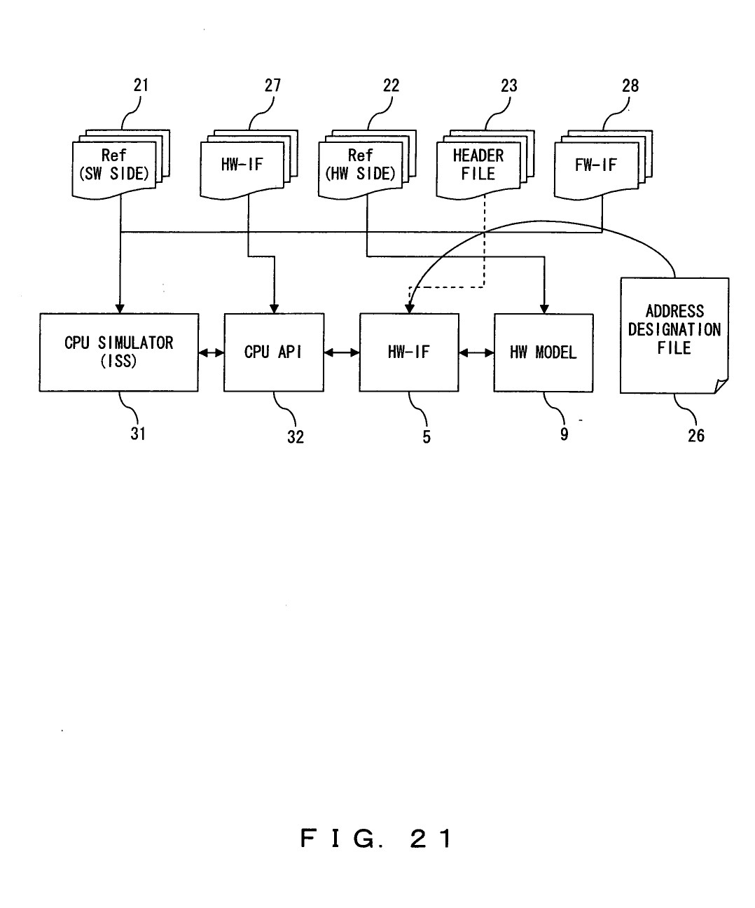

FIG. 21 is a flow chart of a process for generating an (e) CPU+HW model. This model can be generated directly from the (c) Ref-SW+Ref-HW model, or by way of the (d) CPU model as described in association with FIG. 2, the description here, however, assumes that it is directly generated from the (c) model.

In FIG. 21, a process is performed by using a source file described in association with FIG. 13, that is, the Ref (SW side) 21, and the Ref (HW side) 22, header file 23, HW-IF 27 and FW-IF 28 generated as a separate file from the source file 21 for example. The source file 21 and FW-IF 28 are given to a CPU simulator 31, e.g., an ISS. The HW-IF 27 is given to a CPU application program interface (API) 32 as an interface between the CPU simulator 31 and HW-IF 5. The Ref (HW side) 22 is given to the HW model 9 and the address designation file 26 is given to the HW-IF 5. And the HW-IF 5 refers to a content of the header file 23 (which is shown by a dotted line).

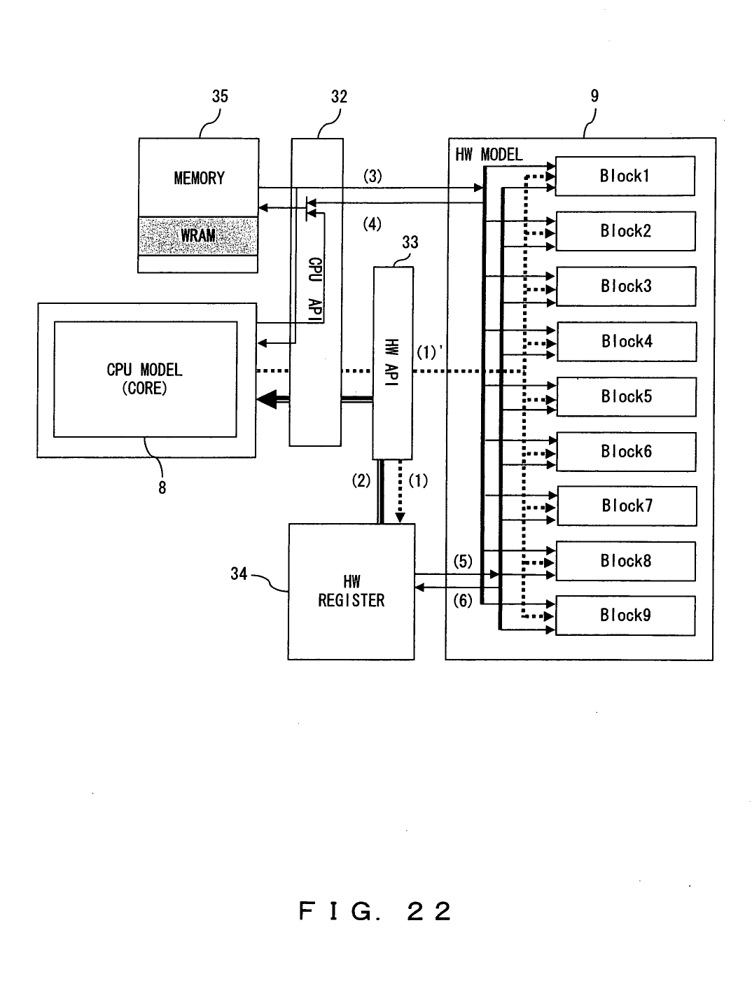

The next description is of an operation and a memory access of the (e) CPU+HW model by referring to FIGS. 22 through 25. FIG. 22 is a description diagram of a basic operation between a (core) CPU model and a HW model (i.e., a user hardware) 9. Referring to FIG. 22, a HW API 33, in addition to the CPU API 32 described in association with FIG. 21, exists between the CPU model 8 and HW model 9.

In FIG. 22, the path (1) indicates one for a write access to a HW register 34 from the CPU model 8 side, while the (1) indicates an execution of a HW block responding to the aforementioned access, that is, an execution of a math function. The path (2) indicates one for a data read to the CPU model 8 from the HW register 34, while the (3) and (4) indicate paths for individual blocks within the HW model 9 to access to memory 35. A direct access is performed from the HW model 9 to the

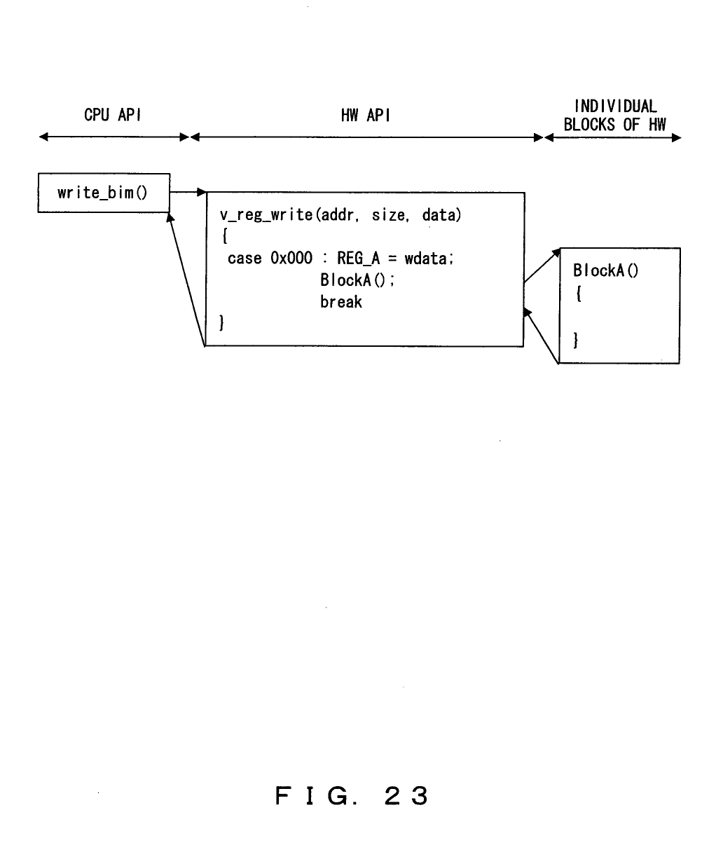

FIG. 23 exemplifies an operation for the (core) CPU model 8 starting up user hardware, that is, each block within the HW model 9. As the CPU model 8 accesses the HW register 34 by way of the CPU API 32 and HW API 33 to write to a register, internal blocks of the HW model 9 are started up, and the respective execution results of the blocks are returned to the (core) CPU model 8 by way of the HW API 33 and CPU API 32.

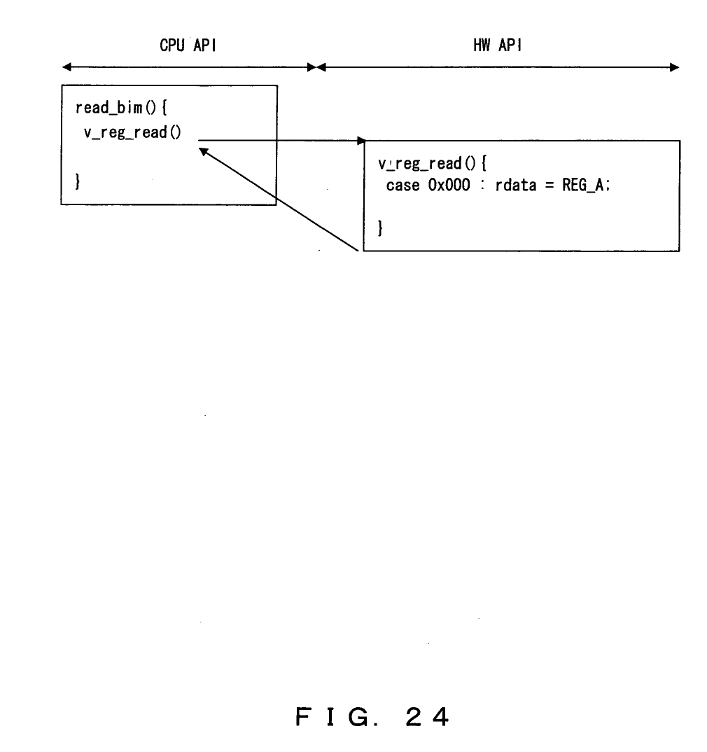

FIG. 24 exemplifies an operation in the case of reading data of the hardware register 34 from the CPU model 8 side. A data read of the HW register 34 by a “v_reg_read” as a HW API 33 by using a “read_bim” as a CPU_API 32.

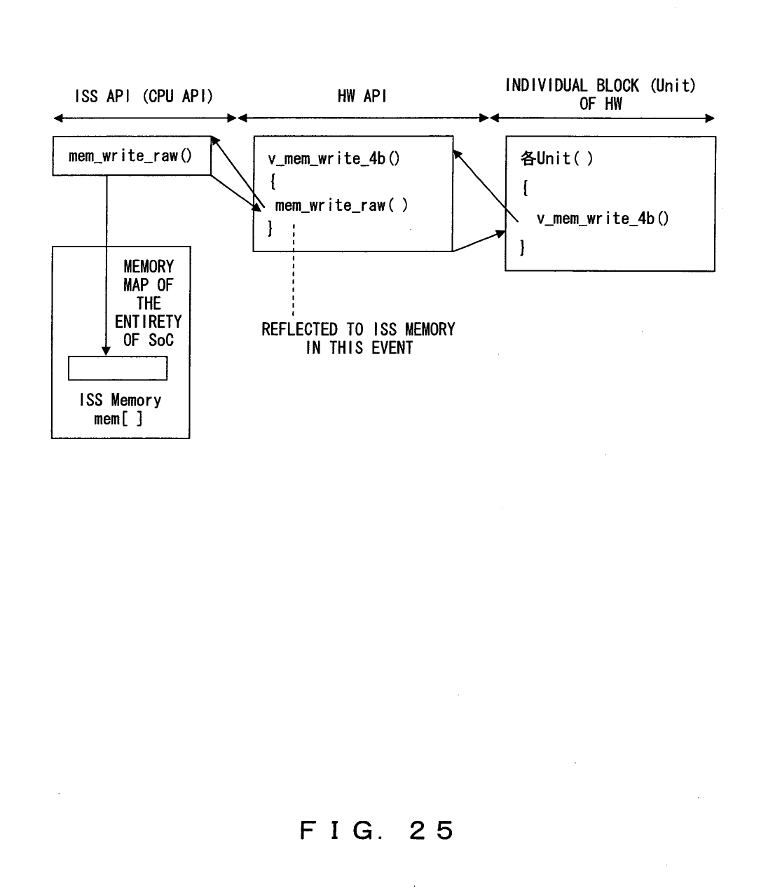

FIG. 25 is a description diagram of an access from user hardware, that is, a HW block to the memory 35. A “v_memory_write” as a HW API 33 and a “mem_write_raw” as a CPU API 32 are called from the HW block, thereby accessing to a memory zone. Then, a reflection of data to a memory zone of the ISS as the CPU model is performed within a memory map of the entirety of the SoC by the “mem_write_raw” as the HW API 33.

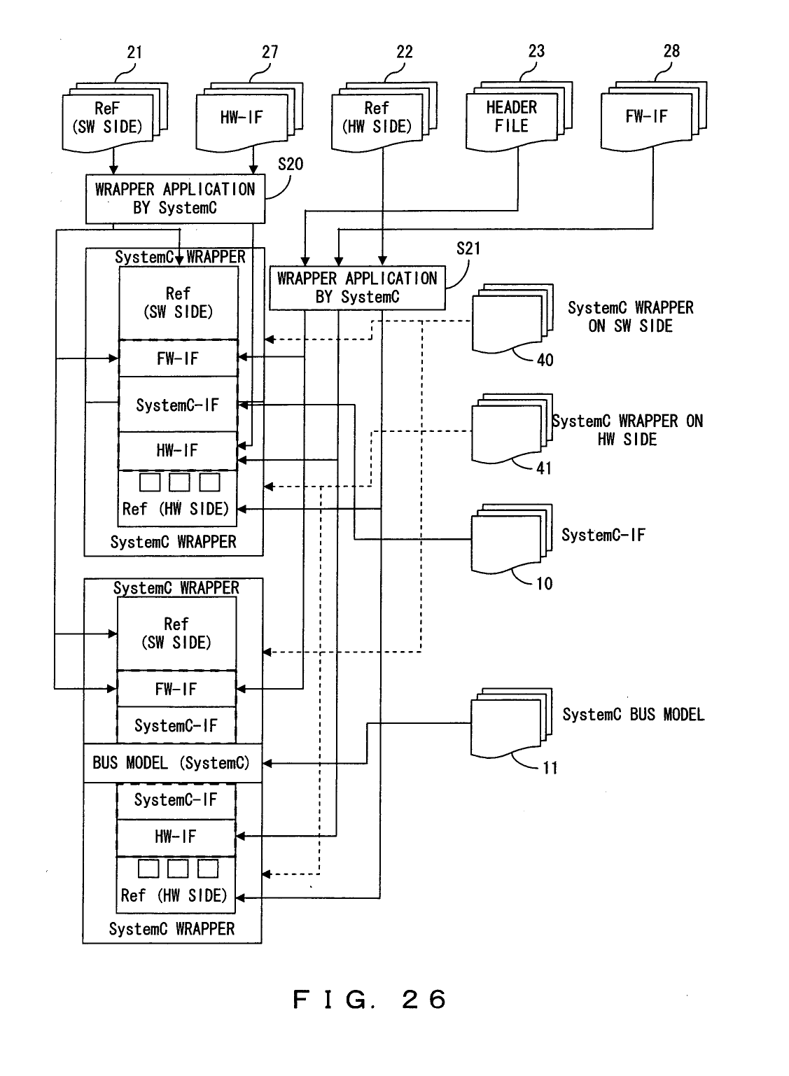

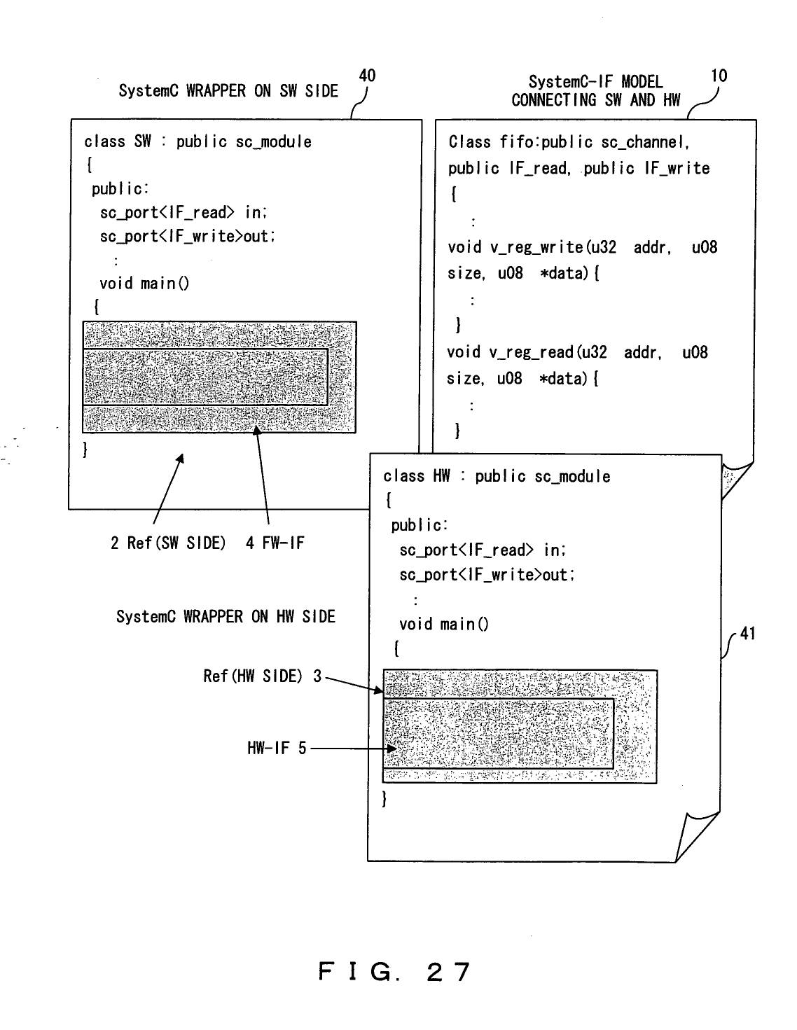

The next description is of generating performance models by referring to FIGS. 26 through 29. FIGS. 26 and 27 show a flow chart of a generation process of a performance model, that is, an (f) Ref-SW+Ref-HW (SystemC) model, generated from the (c) Ref-SW+Ref-HW model as described for FIG. 4.

The upper part of FIG. 26 shows a flow chart of a generation process of the (f1) model described in FIG. 4, that is, the performance model without a bus, in which a SystemC wrapper process is performed in the steps S20 and S21 in response to the input of the Ref (SW side) 21, Ref (HW side) 22, header file 23, HW-IF 27 and FW-IF 28 as in the case of FIG. 21 for example, thereby making as a SystemC wrapper on SW side 40 and a SystemC wrapper on HW side 41. Then, a code within the input file is applied by the SystemC code by using the SystemC-IF 10 described in FIG. 5A and the (f1) performance model without a bus is generated. This flow chart shows basically a process of merely assembling a model by using an input file; it is, however, of course possible to perform it as an automated process by using a tool.

The lower part of FIG. 26 shows a generation of the (f2) model shown in FIG. 5B, that is, the performance model equipped with a bus. A series of files are input as in the case of generating the (f1) model, a SW side is connected to a HW side by using a bus model (SystemC) 11 and the SystemC-IF 10 is divided into the SW side and HW side.

FIG. 27 exemplifies a generation of the (f1), that is, the performance model without a bus. Referring to FIG. 27, the Ref (SW side) 2 and FW-IF 4 are wrapped by a SystemC wrapper on SW side 40 on the SW side, while the Ref (HW side) 3 and HW-IF 5 are wrapped by a SystemC wrapper on HW side 41 on the HW side, and both sides are interconnected by the SystemC-IF 10.

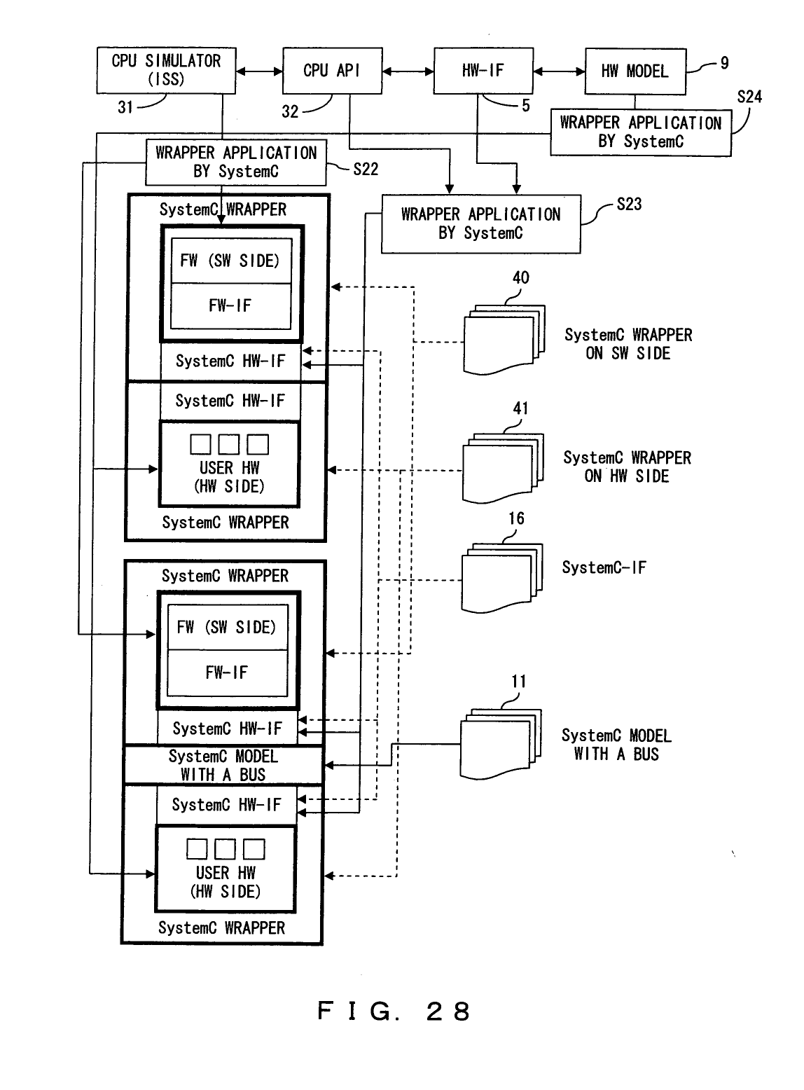

FIG. 28 is a flow chart of a process for generating a (g) CPU+HW (SystemC) model. The (g) model is generated based on the (e) CPU+HW model as described in FIG. 4, and there are a (g1) model without a bus and a (g2) model equipped with a bus as described in FIGS. 6 and 7.

Referring to FIG. 28, the CPU simulator (ISS) 31, CPU API 32, HW-IF 5 and HW model 9 as components of the (e) model which has been generated in FIG. 21 are applied by the SystemC wrapper in the processes of the steps S22 through S24, respectively, followed by a SystemC wrapper on SW side 40 and a SystemC wrapper on HW side 41 being made as in the case of FIG. 26, and by a HW-IF of SystemC 16 being given, thereby generating the (g1) performance model without a bus. Further given is a SystemC model of bus 19, thereby generating the (g2) performance model equipped with a bus.

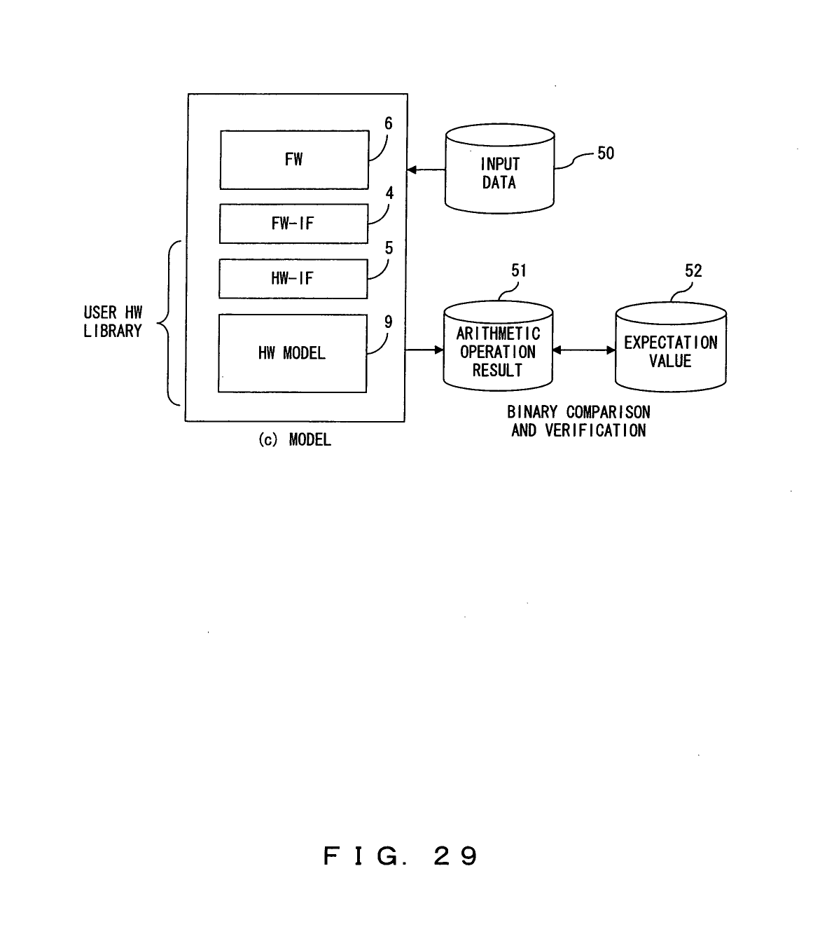

The next description is of a method for verifying the models according to the present embodiment by referring to FIGS. 29 through 31. FIG. 29 is a description diagram of a verification method for the second merge model, that is, the (c) Ref-SW+Ref-HW model. Referring to FIG. 29, input data 50 is given to the (c) model constituted by the FW 6, FW-IF 4, HW-IF 5 and HW model 9, the obtained arithmetic operation result 51 as binary data is compared to an expectation value 52, thereby performing a verification. The input data 50 and expectation value 52 are the same as one being generated against a reference source and the second merge model is handled as a black box and the arithmetic operation result is compared with the expectation value, thereby performing the verification. Here, the assumption is that the HW-IF 5 and HW model 9 are selected from a storage content of a user hardware library for example. Note that it is possible to verify an internal arithmetic operation result in lieu of a final arithmetic operation result, depending on a model.

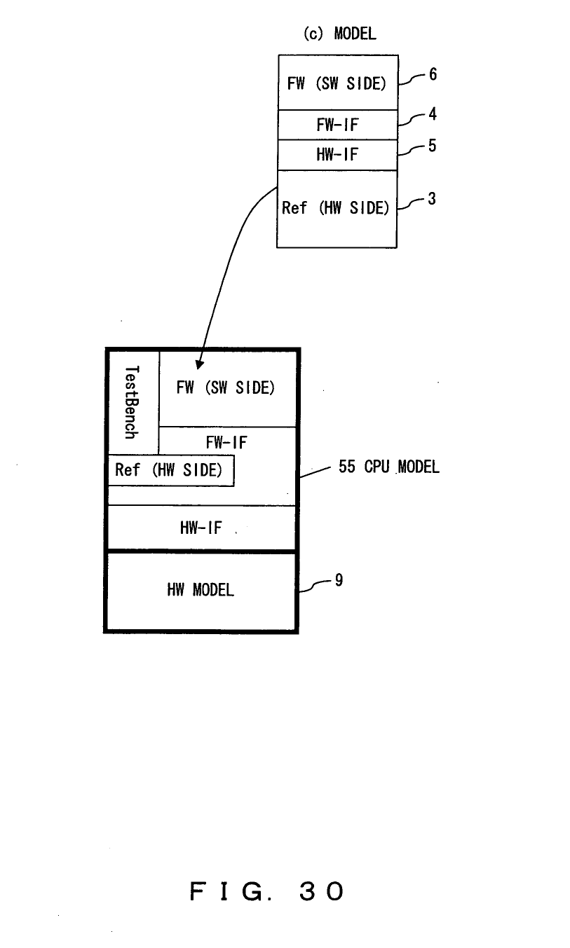

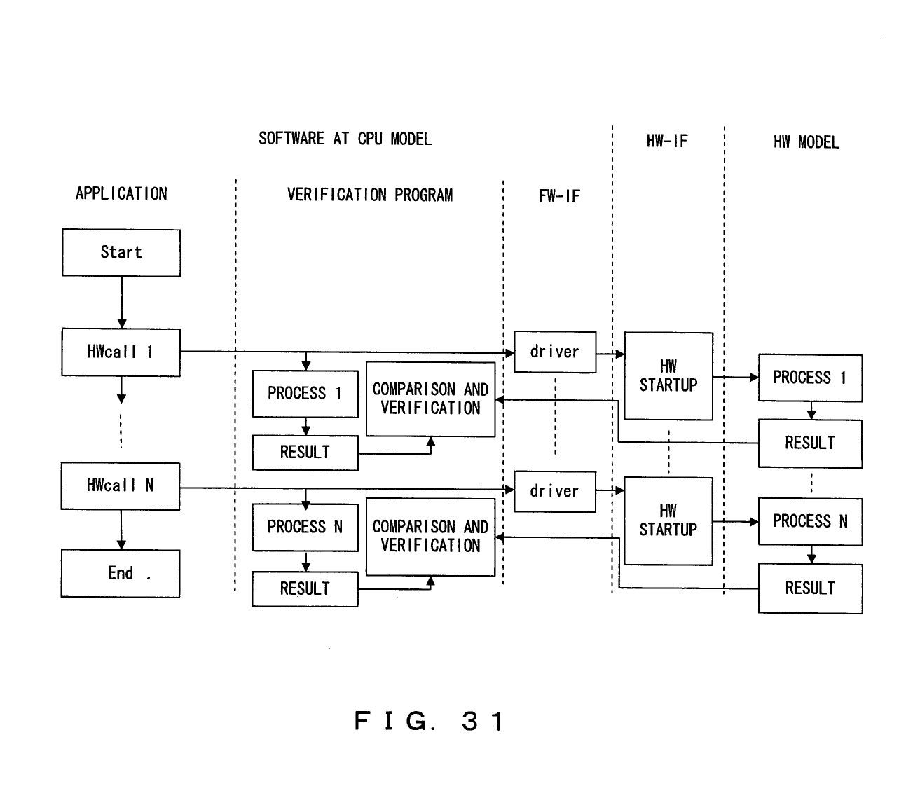

FIGS. 30 and 31 each is a description diagram of a verification method for a HW model, that is, user hardware by utilizing a CPU model. Referring to FIG. 30, a (d) CPU model 55 generated from the (c) model for example is loaded onto a core side of the (e) SoC model, generates an expectation value at the core and also executes a process of the HW model 9, that is, user hardware, thereby enabling a verification of the user hardware.

That is, the FW (SW side) 6, FW-TF 4, HW-IF 5 and Ref (HW side) 3, together with a test bench, constitute the CPU model 55 which is connected to the HW model 9, thereby performing a verification of the HW model, that is, the user hardware.

FIG. 31 is a flow chart of a verification process for the HW model shown in FIG. 30, that is, the user hardware. As an application starts up in software at the CPU model, a hardware call is performed by way of the FW-IF, that is, a driver, the hardware is started up by the HW-IF, a process is performed at the HW model and the result is returned to a verification program on the software side at the CPU model. Meanwhile, the same process is performed on the software side simultaneously with the hardware call, and the result is compared with the result which is returned from the HW model, thereby performing the verification. A repetition of such hardware calls to complete the application, when the verification of the HW model, that is, the user hardware ends.

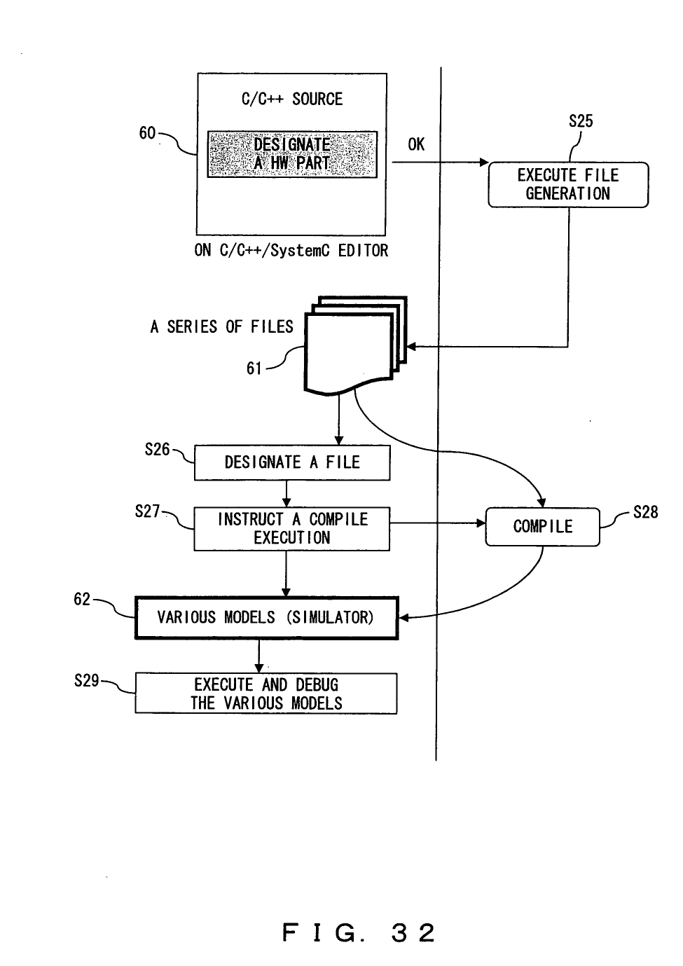

It is possible to provide the SoC design method described in detail above as a design tool furnished with a GUI. FIG. 32 is an overall flow chart of a process using such a design tool. Referring to FIG. 32, the right side shows a process at the tool, while the left side shows that on the GUI side, e.g., a process including a user designation. First on the GUI side, a HW part is designated on a C/C++/SystemC editor for a C/C++ source code 60, for example, which is handed to a file generation execution process in the step S25 on the tool side, a file is designated for the generated series of files 61 in the step S26 on the GUI side and a compile execution is instructed in the step S27. A compile process is carried out in the step S28 on the tool side, various models (i.e., simulators) 62 are generated and an execution and debug of the various models are performed in the step S29 on the GUI side.

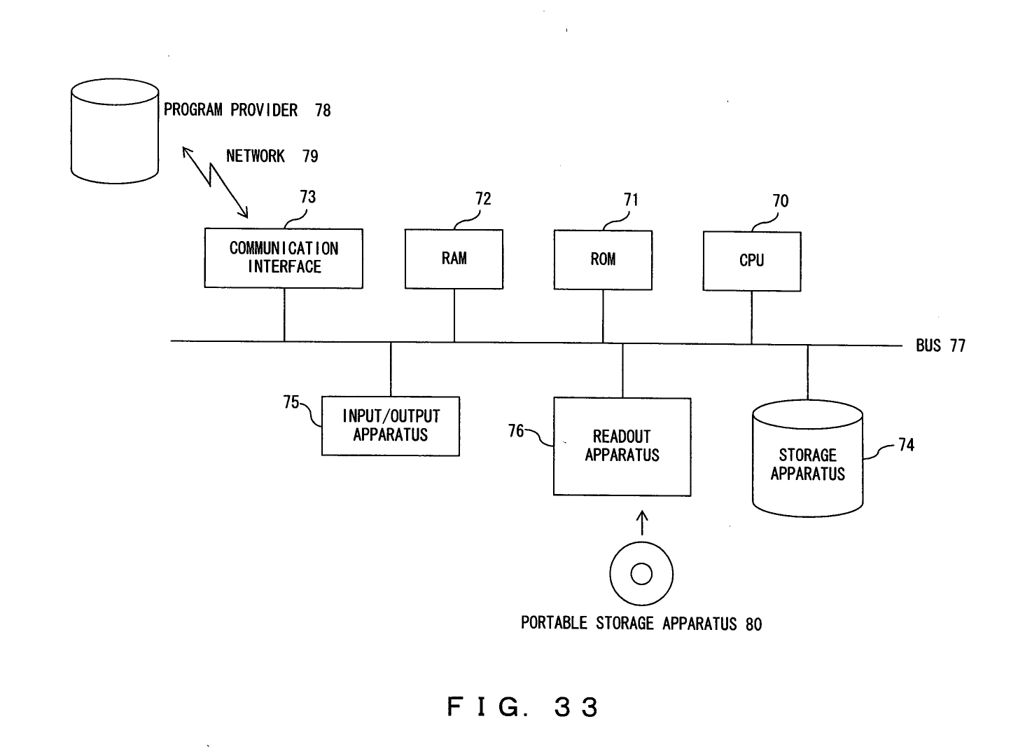

As such, the details of the model generation method for a software/hardware collaboration design have been described. A design apparatus using such a program about a method for generating a model as a tool can of course be configured basically as a common computer system. FIG. 33 is a block diagram showing a configuration of such a computer system, that is, a hardware environment.

Referring to FIG. 33, the computer system comprises a central processing unit (CPU) 70, read only memory (ROM) 71, random access memory (RAM) 72, a communication interface 73, a storage apparatus 74, an input/output apparatus 75, a portable storage media readout apparatus 76 and a bus 77 which is for interconnecting the aforementioned components.

The storage apparatus can use various forms of storage apparatus such as hard disk and magnetic disk. Such a storage apparatus 74, or ROM 71, stores programs about a method for generating a model shown by flow charts of FIGS. 3, 8, 9, 13, 19 through 21, 26 and 28, and programs about a method for generating a model of the claims 1 through 7, 10, 11, 13 and 15 of the present invention so as to be executed by the CPU 70, thereby enabling the phased designs in the form of guaranteeing the same operation according to the present embodiment and the simplification of a SoC design by a tool using the aforementioned modeling method.

Such programs about a method for generating a model can be provided by a program provider 78 by way of a network 79 and a communication interface 73 to be stored in the storage apparatus 74, or stored in a marketed and distributed portable storage medium 80, set in the readout apparatus 76 to be executed by the CPU 70. The portable storage medium can use a various forms of storage media such as CD-ROM, flexible disk, optical disk, magneto optical disk and DVD. The program about a method for generating a model stored in such a storage medium is read by the readout apparatus 76, thereby enabling a model development according to the present embodiment, and verification, et cetera, of an application and algorithm.

What is claimed is:

1. A method for generating a model required for performing a software/hardware collaboration design, comprising:
separating a hardware side from a software side within a reference source as application software, and generating a merge model comprising a firmware interface for the software side to call the hardware side and comprising a hardware interface for enabling an access to a mathematical function or a variable on the hardware side in response to a call from the firmware interface, and
generating a system-on-chip model comprising a central processing apparatus model as a simulator capable of executing the software side and firmware interface within the merge model on an instruction level, a hardware model corresponding to the hardware side and the hardware interface for connecting the central processing apparatus model to the hardware model.

2. The method for generating a model required for performing a software/hardware collaboration design according to claim 1, wherein the method makes a computer further execute, prior to the procedure of generating said system-on-chip model, the procedure of
generating a second central processing apparatus model as a simulator capable of executing, on an instruction level, said merge model as software where said central processing apparatus model is defined as a first central processing apparatus model.

3. The method for generating a model required for performing a software/hardware collaboration design according to claim 1, wherein the method makes a computer further execute, prior to the procedure of generating said merge model, the procedure of
separating a hardware side from a software side within said reference source and generating a first merge model comprising a firmware interface for the software side to call the hardware side where said merge model is defined as a second merge model.

4. The method for generating a model required for performing a software/hardware collaboration design according to claim 1, wherein the method makes a computer further execute, following the procedure of generating said system-on-chip model, the procedure of
performing a pre-process for utilizing each of said central processing apparatus model and hardware model by a system using a language which is different from the currently described language, and generating a performance model connecting the hardware model to the central processing apparatus model that has been preprocessed by an interface which corresponds to said hardware interface and which is described by the different language.

5. The method for generating a model required for performing a software/hardware collaboration design according to claim 1, wherein the method makes a computer further execute, following the procedure of generating said system-on-chip model, the procedure of
performing a pre-process for utilizing each of said central processing apparatus model and hardware model by a system using a language which is different from the currently described language, and generating a performance model equipped with a bus connecting the hardware model with the preprocessed central processing apparatus model by using an interface of a hardware side which corresponds to said hardware interface and which is further described by the different language, an interface on the software side and a model of a bus interconnecting the aforementioned two interfaces.

6. The method for generating a model required for performing a software/hardware collaboration design according to claim 1, wherein
said hardware interface comprises an Endian conversion function for converting a sort sequence of bytes at the time of said hardware side transmitting and recording data into a sort sequence used by a central processing apparatus executing said software side.

7. The method for generating a model required for performing a software/hardware collaboration design according to claim 1, wherein
a variable and/or a mathematical function which are commonly used by said software and hardware sides are defined as different variables and/or mathematical functions in the software and hardware sides.

8. A method for generating a model required for performing a software/hardware collaboration design, comprising:
separating a hardware side from a software side within a reference source as application software, and generating a merge model comprising a firmware interface for the software side to call the hardware side, and
generating a central processing apparatus model as a simulator capable of executing the merge model and a hardware interface enabling an access to a mathematical function or a variable on the hardware side in response to a call from the firmware interface on an instruction level as software.

9. A method for generating a model required for performing a software/hardware collaboration design according to claim 1, wherein:
performing a preprocess for utilizing the software side, the hardware side, the firmware interface and the hardware interface by a system using a language different from the currently described language, and generating a performance merge model connecting the preprocessed firmware interface to the hardware interface by way of an interface which is described by a further different language.

10. A method for generating a model required for performing a software/hardware collaboration design according to claim 1, wherein
performing a preprocess for utilizing the software side, the hardware side, the firmware interface and the hardware interface by a system using a language different from the currently described language, and generating a performance merge model equipped with a bus connecting a first interface, which is connected to the firmware interface and is further described by the different language, to a second interface, which is connected to the hardware interface and is further described by the different language, by a model of the bus described by the different language.
